(19) United States
(12) Patent Application Publication
(10) Pub. No.: US 2009/0297401 A1
(43) Pub. Date: Dec. 3, 2009

(54) SENSOR KIT AND A SYSTEM FOR DETECTING AN ANALYTE IN A TEST ENVIRONMENT

(75) Inventors: Ingemar Lundström, Linköping (SE); Daniel Filippini, Linköping (SE); Corrado Di Natale, Roma (IT)

Correspondence Address: VENABLE LLP, P.O. BOX 34385, WASHINGTON, DC, 20043-9998, US

(73) Assignee: RGB Technologies AB, Stockholm (SE)

(21) Appl. No.: 12/306,724

(22) PCT Filed: Jun. 28, 2007
(86) PCT No.: PCT/SE07/50474

§ 371 Date: Dec. 27, 2008

Related U.S. Application Data
(60) Provisional application No. 60/816,883, filed on Jun. 28, 2006.

(51) Int. Cl. G01J 3/00

(52) U.S. Cl. 422/82.05

(57) ABSTRACT

A sensor kit for detecting an analyte. The sensor kit includes x indicator substances having a specific spectral response to the analyte, whereby 1≧x≦200. The sensor kit includes a substrate, which is to be illuminated on a first side and includes at least one indicator substance region arranged adjacent to a second side. Each indicator substance region is arranged for carrying one indicator substance and the substrate includes at least one indicator substance region for each indicator substance. A filter element is integrated with the substrate. The filter element includes at least one of each of n different filters, whereby 2≦n≦100. The filter element is arranged such that light firstly passes there through and thereafter through the indicator substance region(s). At least one of each of at least two different filters provides at least one indicator substance region with light when the substrate is illuminated.

### TECHNICAL FIELD

The present invention relates to a sensor kit for detecting an analyte in a test environment, which sensor kit comprises at least one indicator substance and a substrate arranged for carrying the indicator substances. Each indicator substance has a specific spectral response to the analyte to be detected. Furthermore, the present invention relates to a system for detecting an analyte in a test environment, which system comprises the sensor kit according to the invention.

### BACKGROUND OF THE INVENTION

In many different technical fields it is for various reasons desired or necessary to be able to detect one or more analytes in a test environment, which may be gaseous, liquid or solid. For example, it might be desired or necessary to detect poisonous gases or toxins in air; toxins, additives, flavorings, etc. in foodstuff; environmental pollutants in e.g. air or water; hormones or other substances in blood or urine samples; bacteria or viruses in different types of samples; or surface proteins, oligosaccharides, antigens, nucleic acid sequences, etc. in bioassays.

Today there are many known methods and devices for detection of an analyte in a test environment. The known methods and devices are based on many different techniques and are of varying complexity. One technique for detecting an analyte in a test environment is the so-called Computer Screen Photo-assisted Technique (CSPT).

WO 03/067936 describes a method and a system for detection of an analyte in a test environment, which are based on the CSPT. In the method described in WO 03/067936 an indicator substance is provided in or in contact with the test environment in which the analyte is to be detected. The indicator substance is designed to change its spectral response upon interaction with the analyte, i.e. it changes its spectral response in case the analyte is present in the test environment. A program controlled display such as e.g. a computer screen, a mobile phone display or a TV screen is utilized as a light source for illuminating the indicator substance. More specifically, the display is utilized for delivering a controlled sequence of illuminating colors onto the indicator substance, i.e. it is utilized for delivering light within different spectral bands. The controlled sequence is obtained by individually programming the pixels with respect to colour and intensity. The spectral response of the indicator substance upon illumination by the display is detected by means of a detector such as e.g. a web camera or a digital camera. Since the indicator substance is designed to change its spectral response if the analyte to be detected is present in the test environment, the analyte may be detected.

Thus, in the CSPT a program controlled display such as e.g. a computer screen is utilized in combination with a detector such as e.g. a web camera for optical characterization of indicator substances which optical properties, e.g. the spectral response, change upon interaction with an analyte. It is also known to utilize the CSPT for optical characterization of arrays comprising at least two different indicator substances which optical properties, e.g. the spectral response, change upon interaction with an analyte (1-8). The indicator substances may be, for instance, chemically sensitive to one or more certain analytes that affect their spectral characteristics, whereby the change in these spectral characteristics is captured by CSPT. They may be color indicator substances (i.e. indicator substances changing colour upon interaction with an analyte, e.g. dyes) or fluorescent indicator substances.

Furthermore, the CSPT may be used for spectral fingerprinting of indicator substances, which spectral response change upon interaction with an analyte (1, 3, 6-8). The indicator substances are then preferably comprised in a two-dimensionally spatially resolved array, whereby the array of indicator substances may be contained in, for example, diverse format plates (1, 2, 6, 8). A typical CSPT arrangement for this purpose illuminates the array of indicator substances with a particular sequence of colors displayed on the computer screen, i.e. the array of indicator substances are sequentially illuminated with light within different spectral bands, and a digital or a web camera captures the image of the array of indicator substances, in synchronism with the illumination. By means of the illumination of the array of indicator substances by light within different spectral bands and by means of numeric processing of the video stream acquired by the detector, spectral features of the indicator substances that constitute selective fingerprints may be obtained. The fingerprints can be used to identify them or to identify the target stimuli, i.e. the analyte, that alter them. In this way CSPT constitutes a tool for imaging (bio) chemically responsive assays. Since CSPT is an imaging technique, any possible layout of the substances can be evaluated just by numerically locating the regions of interest on the substance coordinates.

The properties of CSPT for evaluating color or fluorescent indicator substances rely on the wide band, partially overlapping and differently shaped screen primary spectral radiances and web camera filters (9-10). The relative intensities of the primary radiances can be optimized to differentiate specific sets of indicator substances (11).

Liquid crystal displays (LCD) produce the three primary spectral radiances by interposing wide band filters (that stimulate the human perception of red, green and blue colors) on each pixel of a computer display. The larger the number of these filters the higher the spectral resolution of the display, but also the larger the number of different elements that compose each image pixel, and for the same display and element size the lower the spatial resolution of the display. In commercial displays the number of filters is limited to three, giving rise to red, green and blue primaries. For CSPT evaluations, the spatial resolution of the display is not necessarily a limiting factor since in many applications the screen is used as a large area light source. It is, however, recognized that for these applications an increased spectral resolution will be beneficial (10).

Thus, a system for detecting an analyte in a test environment based on the CSPT comprises one or more indicator substances having a specific spectral response if the analyte is present in the test environment, a substrate arranged for carrying the indicator substances, a display such as e.g. a computer screen for providing the indicator substances with light within specific spectral bands and a detector such as e.g. a web camera for detection of the spectral response of the indicator substances. The substrate may have e.g. a plate-like form and may be arranged for carrying indicator substances in a two dimensionally spatially resolved manner. The combination of the substrate and the indicator substances may be denoted as a sensor kit for detecting an analyte in a test environment.

The indicator substances of the sensor kit utilized in CSPT have to be illuminated by the display in order for them to be provided with light within a plurality of specific spectral bands. There are also other known techniques in which a sensor kit of the mentioned type is utilized and in which the indicators have to be illuminated by a specific light source in order for them to be provided with light within a plurality of specific spectral bands.

However, it would be appreciated to not being limited to utilization of a specific light source for providing the indicator substances of a sensor kit of the above mentioned type with light within a plurality of specific spectral bands. Thus, there is still a need for a sensor kit of the above mentioned type which eliminates the need of utilization of a specific light source such as e.g. a computer screen, or any other light source capable of delivering light within a plurality of specific spectral bands, in order to provide the indicator substances with light within a plurality of specific spectral bands.

### SUMMARY OF THE INVENTION

Accordingly, one object of the present invention is to provide an improved sensor kit for detecting an analyte in a test environment, which sensor kit comprises:
x indicator substances, whereby 1≦x≦200, whereby each indicator substance has a specific spectral response to the analyte; and
a substrate arranged for carrying the indicator substances, whereby the substrate comprises a first side and a second side opposite to the first side, whereby the substrate is arranged to be illuminated by a light source on the first side, whereby the substrate comprises at least one indicator substance region arranged adjacent to the second side, whereby each indicator substance region is arranged for carrying one indicator substance and whereby the substrate comprises at least one indicator substance region for each indicator substance.

This object is achieved in accordance with the characterizing portion of claim 1.

Preferred embodiments are listed in the dependent claims.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures described herein.

### BRIEF DESCRIPTION OF THE DRAWINGS

In the drawings, wherein like reference characters denote similar elements throughout the several views:

FIG. 1a shows schematically a top view of a first embodiment of a sensor kit according to the invention;

FIG. 1b shows schematically a side view of the first embodiment of the sensor kit;

FIG. 1c shows a top view of a variant of the first embodiment of the sensor kit;

FIG. 1d shows a further variant of the first embodiment of the sensor kit;

FIG. 1e shows the first embodiment of the sensor kit with a diffuser;

FIG. 2a shows schematically a top view of a second embodiment of a sensor kit according to the invention;

FIG. 2b shows schematically a side view of the second embodiment of the sensor kit;

FIG. 2c shows a top view of a variant of the second embodiment of the sensor kit;

FIG. 3a shows schematically a top view of a third embodiment of a sensor kit according to the invention;

FIG. 3b shows schematically a side view of the third embodiment of the sensor kit;

FIG. 3c shows a top view of a variant of the third embodiment of the sensor kit;

FIG. 4a shows schematically a top view of a fourth embodiment of a sensor kit according to the invention;

FIG. 4b shows schematically a side view of the fourth embodiment of the sensor kit;

FIG. 5a shows schematically a top view of a fifth embodiment of a sensor kit according to the invention;

FIG. 5b shows schematically a side view of the fifth embodiment of the sensor kit;

FIG. 6 shows schematically a side view of a system according to the invention comprising the first embodiment of the sensor kit according to the invention;

FIG. 7 shows an experimental implementation of the variant of the third embodiment of the sensor kit shown in FIG. 3c;

FIG. 8a shows an optical fingerprint of the analyte triethylamine obtained with the sensor kit shown in FIG. 7;

FIG. 8b shows an optical fingerprint of the analyte acetic acid obtained with the sensor kit shown in FIG. 7; and

FIG. 9 shows the multivariate classification of fingerprints such as those in FIGS. 8a-b.

### DETAILED DESCRIPTION OF PREFERRED EMBODIMENTS

The present invention provides a sensor kit for detecting an analyte in a test environment. In the present context, the term “analyte” refers to a substance desired to be detected, i.e. the substance subject to analysis. The analyte may be gaseous, liquid or solid. The term “test environment” refers herein to an environment in which the analyte is to be detected. The test environment may be gaseous, liquid or solid. For example, a gas sample, a liquid sample or a sample of a solid material may constitute the test environment.

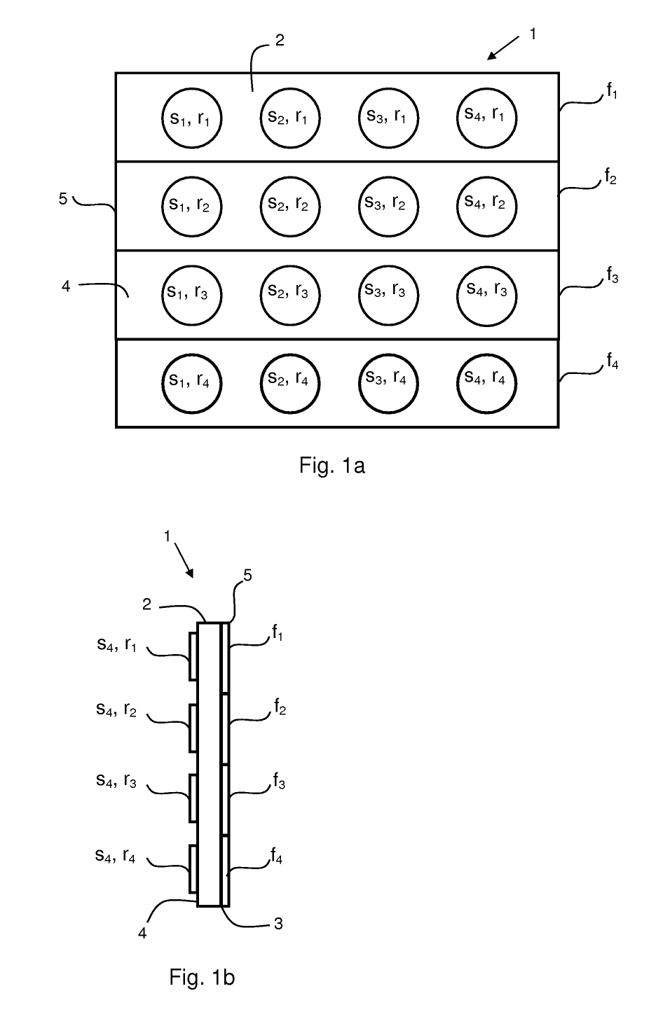

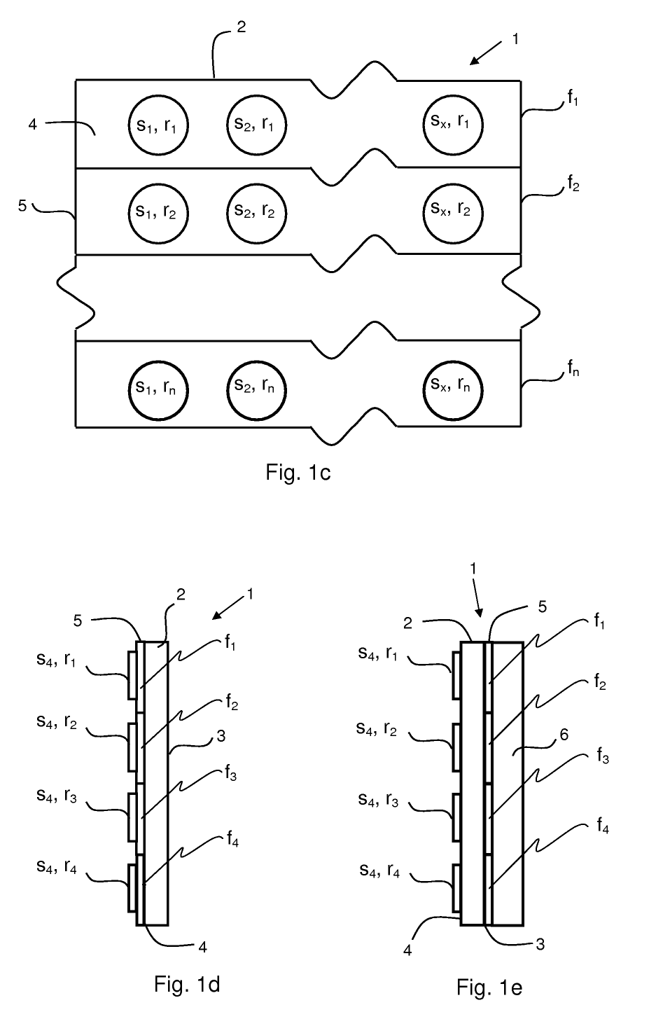

FIGS. 1a and 1b show schematically a top view and a side view, respectively, of a first embodiment of a sensor kit 1 according to the invention. In the first embodiment, the sensor kit 1 comprises four different indicator substances s₁, s₂, s₃, s₄. However, in alternatives to the first embodiment, the sensor kit 1 comprises other numbers of indicator substances. This will be further described below. The respective indicator substances s₁, s₂, s₃, s₄ may be any known indicator substances that may be utilized for detection of an analyte in a test environment based on measurements of changes of their spectral response. The specific indicator substances constituting the respective indicator substances s₁, s₂, s₃, s₄ depend on which analyte that is to be detected by the sensor kit 1.

However, each indicator substance s₁, s₂, s₃, s₄ comprised in the sensor kit 1 has a specific spectral response to the analyte to be detected, i.e. each indicator substance s₁, s₂, s₃, s₄ has a specific spectral response in case the analyte is present in the test environment. The specific spectral response of the respective indicator substances s₁, s₂, s₃, s₄ to the analyte to be detected may either be changed or unchanged compared to the spectral response thereof in case the analyte is not present. However, at least one of the indicator substances s₁, s₂, s₃, s₄ comprised in the sensor kit 1 changes its spectral response in case the analyte to be detected is present in the test environment.

Thus, all the indicator substances s₁, s₂, s₃, s₄ of the sensor kit 1 in combination have a specific spectral response to the analyte to be detected, i.e. they provide in combination a spectral response distinct to an analyte to be detected.

The indicator substances s₁, s₂, s₃, s₄ may be color indicator substances (i.e. indicator substances changing colour upon interaction with an analyte, e.g. dyes) or fluorescent indicator substances. Thus, a change of the spectral response of an indicator substance may involve change of color, absorption and/or emission. For example, the indicator substances s₁, s₂, s₃, s₄ may be selected from the group consisting of: porphyrins, metalloporphyrins, chlorines, chlorophylls, phtahalocyanines, salens, fluorophores, conductive polymers, fluorescence amplifying proteins, polythiofenes, nanoparticles and plasmonic nanoparticles.

In case the indicator substances s₁, s₂, s₃, s₄ are metalloporphyrines, they may be e.g. metalloporphyrines having a metal ion selected from the group consisting of Sn⁴⁺, Co³⁺, Cr³⁺, Mn³⁺, Fe³⁺, Co²⁺, Cu²⁺, Ru²⁺, Zn²⁺ and Ag²⁺.

A change of the spectral response of an indicator substance may be due to any type of interaction between an analyte and the indicator substance. The specific interaction resulting in a change of the spectral response of an indicator substance depends on the type of the indicator substance and the analyte. The interaction may be e.g. a covalent interaction or a non-covalent interaction, such as e.g. ligation, binding, hydrogen bonding, pi-pi-complexation or polarity induced shifts in color.

Furthermore, in the first embodiment the sensor kit 1 comprises further a substrate 2, which preferably is plate-like, i.e. it has the form of a plate, slide or the like. For example, it may be a plate or a slide. The substrate 2 may be made of any suitable material. For example, it may be made of a metal, glass, a polymer, paper, a filter paper, a chromatography plate or a porous membrane. The substrate 2 is arranged for carrying the indicator substances s₁, s₂, s₃, s₄ and comprises a first side 3 and a second side 4 opposite to the first side 3. The substrate 2 is arranged to be illuminated by a light source on the first side 3. The light source may be any suitable light source. For example, it may be a wide band light source, i.e. a light source providing light within a plurality of spectral bands, such as e.g. a light source providing white light, or sun light. More specifically, the substrate 2 is arranged to be illuminated by a light source in such a way that light firstly passes through the first side 3 and thereafter passes through the interior of the substrate 2, where after it emerges through the second side 4.

Furthermore, the substrate 2 comprises a plurality of indicator substance regions on the second side 4. Each indicator substance region is arranged for carrying one indicator substance s₁, s₂, s₃, s₄. More specifically, in the first embodiment the substrate 2 comprises four indicator substance regions r₁, r₂, r₃, r₄ for each indicator substance s₁, s₂, s₃, s₄ on the second side 4, i.e. for the indicator substance s₁ it comprises four indicator substance regions r₁, r₂, r₃, r₄, for the indicator substance sₛ it comprises tour indicator substance regions r₁, r₂, r₃, r₄, etc. Thus, in total it comprises 4*4=16 different indicator substance regions on the second side 4. The indicator substance regions r₁, r₂, r₃, r₄ are two-dimensionally spatially resolved. For purposes of illustration, the indicator substance regions r₁, r₂, r₃, r₄ are shown as circles in FIG. 1a. In alternatives to the first embodiment, the substrate comprises other numbers of indicator substance regions for each indicator substance. This will be further described below.

As mentioned above, in the first embodiment the indicator substance regions r₁, r₂, r₃, r₄ are arranged on the second side 4. However, the indicator substance regions r₁, r₂, r₃, r₄ may likewise be arranged within the substrate 2 at the second side 4. Whether the indicator substance regions r₁, r₂, r₃, r₄ are arranged on the second side 4 or within the substrate 2 at the second side 4 depends on which type of substrate that is utilized and on the material of the substrate. For example, in case the substrate 2 is a glass plate the indicator substance regions are preferably arranged on the second side 4. However, in case the substrate 2 is a chromatography plate the indicator substance regions are preferably located within the substrate 2 at the second side 4. In all cases, the indicator substance regions r₁, r₂, r₃, r₄ are, however, arranged adjacent to the second side 4.

In the first embodiment shown in FIGS. 1a and 1b the indicator substances s₁, s₂, s₃, s₄ are present in the respective indicator substance regions r₁, r₂, r₃, r₄, i.e. they have been provided in the respective indicator substance regions r₁, r₂, r₃, r₄ during manufacture of the sensor kit 1. Depending on which type of substrate that is utilized and on the material of the substrate, the indicator substances s₁, s₂, s₃, s₄ may be provided in the indicator substance regions r₁, r₂, r₃, r₄ by means of e.g. chromatography or by direct deposition, including ink-jet printing, micropipette spotting, screen printing and stamping.

However, alternatively the indicator substances s₁, s₂, s₃, s₄ may be provided separate from said substrate 2, i.e. the sensor kit 1 may comprise the substrate 2 and separate indicator substances s₁, s₂, s₃, s₄. The indicator substances s₁, s₂, s₃, s₄ are then not provided in the respective indicator substance regions r₁, r₂, r₃, r₄ during manufacture of the substrate 2, but are arranged to be provided in the respective indicator substance regions r₁, r₂, r₃, r₄ before use of the sensor kit 1 for detection of an analyte in a test environment.

Furthermore, the substrate 2 may in one alternative be a plate comprising a plurality of wells. Then the side of the plate comprising the wells is the second side 4 and each well constitutes an indicator substance region r₁, r₂, r₃, r₄.

In addition, the sensor kit 1 comprises a filter element 5 integrated with the substrate 2. The filter element 5 is arranged such that light firstly passes through the filter element 5 and thereafter through the indicator substance regions r₁, r₂, r₃, r₄ when the first side 3 of the substrate 2 is illuminated. In the first embodiment, the filter element 5 is arranged on the first side 3 of the substrate 2.

Furthermore, in the first embodiment, the filter element 5 comprises one of each of four different filters f₁, f₂, f₃, f₄. The different filters f₁, f₂, f₃, f₄ are designed such that light within different spectral bands emerge from each of them when the first side 3 of the substrate 2 is illuminated with light from a light source. Thus, light within a first spectral band emerges from a first filter f₁, light within a second spectral band emerges from a second filter f₂, light within a third spectral band emerges from a third filter f₃ and light within a fourth spectral band emerges from a fourth filter f₄. In other words, the different filters f₁, f₂, f₃, f₄ are arranged to allow light within different spectral bands to pass through.

Furthermore, in the first embodiment, each of the filters f₁, f₂, f₃, f₄ is arranged as a separate row in a first direction of the substrate 2. Thus, the filters f₁, f₂, f₃, f₄ form in total four rows. The four indicator substance regions r₁, r₂, r₃, r₄ for each of the indicator substances s₁, s₂, s₃, s₄ are arranged as a separate column in a second direction of the substrate 2, i.e. the indicator substance regions r₁, r₂, r₃, r₄ arranged for carrying the indicator substance denoted s, are arranged in one column, the indicator substance regions r₁, r₂, r₃, r₄ arranged for carrying the indicator substance denoted s₂ are arranged in another column, etc. Thus, in total four different columns are formed. The second direction is transverse to the first direction.

In the first embodiment the filters f₁, f₂, f₃, f₄ and the indicator substance regions r₁, r₂, r₃, r₄ are arranged such that each filter f₁, f₂, f₃, f₄ provides one of the four indicator substance regions r₁, r₂, r₃, r₄ for each of the indicator substances s₁, s₂, s₃, s₄ with light. More specifically, the filter denoted f₁ provides the indicator substance region denoted r₁ for each of the indicator substances s₁, s₂, s₃, s₄ with light, the filter denoted f₂ provides the indicator substance region denoted r₂ for each of the indicator substances s₁, s₂, s₃, s₄ with light, etc. In addition, the filters f₁, f₂, f₃, f₄ and the indicator substance regions r₁, r₂, r₃, r₄ are arranged such that each of the 16 indicator substance regions r₁, r₂, r₃, r₄ is provided with light emerging from one of the filters f₁, f₂, f₃, f₄ only. More specifically, the indicator substance region denoted r₁ for the indicator substance s₁ is only provided with light emerging from the filter f₁, the indicator substance region denoted r₂ for the indicator substance s₁ is only provided with light emerging from the filter f₂, etc.

FIG. 1c shows a top view of a variant of the first embodiment, which variant corresponds to the first embodiment except for concerning the fact that it may comprise other numbers of indicator substances and/or indicator substance regions and/or filters. In the variant of the first embodiment shown in FIG. 1c the sensor kit 1 comprises x indicator substances s₁, s₂ . . . sₓ, the filter element 5 comprises one of each of n different filters f₁, f₂ . . . fₙ, and the substrate 2 comprises n indicator substance regions r₁, r₂ . . . rₙ for each indicator substance s₁, s₂ . . . sₓ. Light within different spectral bands emerges from each of the different filters f₁, f₂ . . . fₙ when said first side 3 of the substrate 2 is illuminated. The filters f₁, f₂ . . . fₙ and the indicator substance regions r₁, r₂ . . . rₙ are arranged such that each filter f₁, f₂ . . . fₙ provides one of the n indicator substance regions r₁, r₂ . . . rₙ for each of the indicator substances s₁, s₂ . . . sₓ with light and such that each indicator substance region r₁, r₂ . . . rₙ is provided with light emerging from one of the filters f₁, f₂ . . . fₙ only when the first side 3 of the substrate 2 is illuminated. In variants corresponding to that shown in FIG. 1c, 1≦x≦200 and 2≦n≦100.

In the variant shown in FIG. 1c each filter f₁, f₂ . . . . fₙ is arranged as a separate row in a first direction of the substrate 2 and the n indicator substance regions r₁, r₂ . . . rₙ for each of the indicator substances s₁, s₂ . . . sₓ are arranged as a separate column in a second direction of the substrate 2. Alternatively, the filters f₁, f₂ . . . fₙ and the indicator substance regions r₁, r₂ . . . rₙ may be arranged in any other way (not shown) than that specific arrangement shown in FIG. 1c. However, they are then also arranged such that each filter f₁, f₂ . . . fₙ provides one of the n indicator substance regions r₁, r₂ . . . rₙ for each of the indicator substances s₁, s₂ . . . sₓ with light and such that each indicator substance region r₁, r₂ . . . rₙ is provided with light emerging from one of the filters f₁, f₂ . . . fₙ only when the first side 3 of the substrate 2 is illuminated.

Optionally, the position of the filter element 5 may be changed in the first embodiment or any of the above mentioned alternatives or variants thereof such that it instead is positioned on the second side 4 of the substrate 2. The indicator substance regions r₁, r₂ . . . rₙ are then provided on the surface of the filter element 5. In other words, the filter element 5 is then interposed between the second side 4 of the substrate 2 and the indicator substance regions r₁, r₂ . . . rₙ. This may be seen as that the indicator substance regions r₁, r₂ . . . rₙ are provided adjacent to the second side 4 of the substrate 2. One example of such a variant is shown in a side view in FIG. 1d, in which a sensor kit 1 is shown that corresponds to the first embodiment except for concerning the position of the filter element 5.

In addition, the first embodiment of the sensor kit 1 or any of the above described alternatives or variants thereof may optionally also comprise a diffuser 6 integrated with the substrate 2. The diffuser 6 is arranged to homogenize the background illumination. Thus, it is arranged such that light firstly passes through the diffuser 6 and thereafter through the filter element 5 when the first side 3 of the substrate 2 is illuminated. FIG. 1e shows the first embodiment with a diffuser 6. As may be seen in FIG. 1e, in case the filter element 5 is arranged on the first side 3 of the substrate 2, the diffuser 6 is arranged on the surface of the filter element 5. In case the filter element 5 instead is arranged on the second side 4 of the substrate 2, the diffuser 6 is arranged on the first side 3 of the substrate 2.

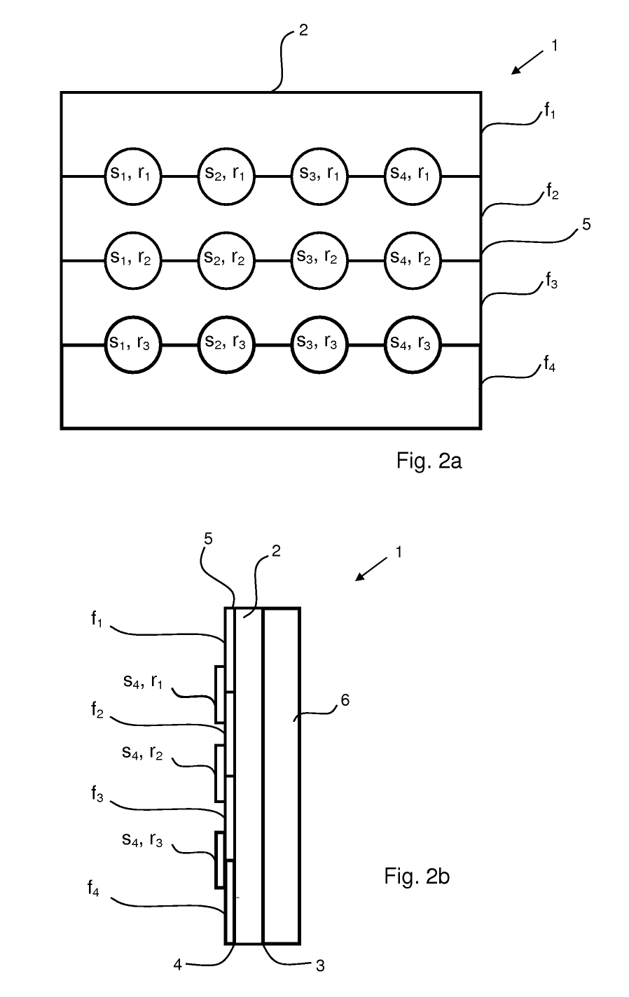

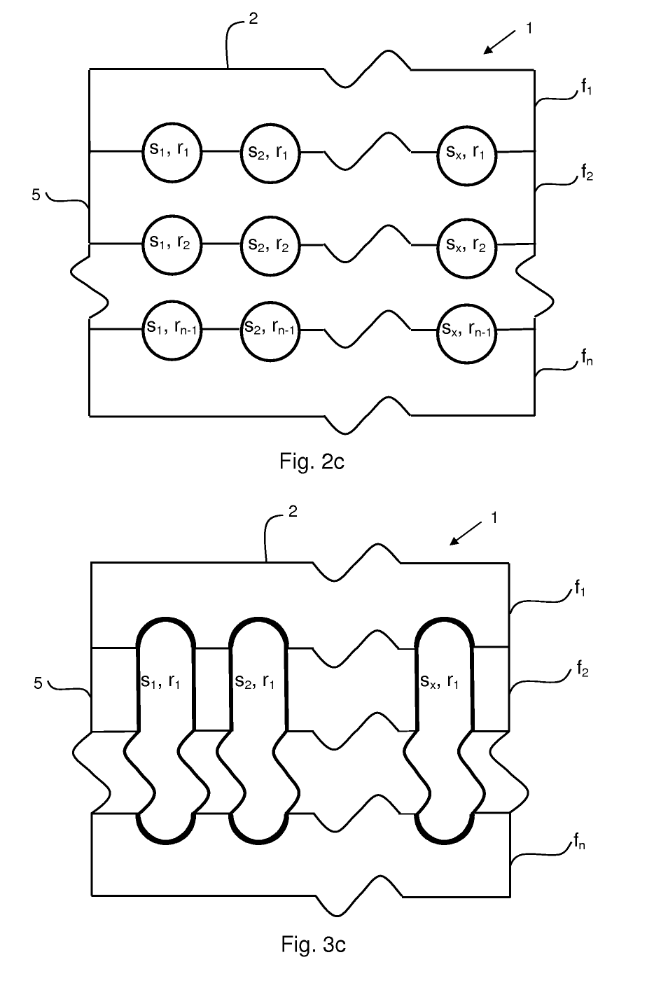

FIGS. 2a and 2b show schematically a top view and a side view, respectively, of a second embodiment of a sensor kit 1 according to the invention. The second embodiment corresponds to the first embodiment of the invention except for concerning the numbers of indicator substance regions, the positioning thereof in relation to the filters and the position of the filter element. Thus, in the second embodiment, the substrate 2 comprises four different indicator substances s₁, s₂, s₃, s₄ and the filter element 5 comprises one of each of four different filters f₁, f₂, f₃, f₄ in correspondence with the first embodiment. The different filters f₁, f₂, f₃, f₄ are designed such that light within different spectral bands emerge from each of them when the first side 3 of the substrate 2 is illuminated with light from a light source. However, the substrate 2 comprises three indicator substance regions r₁, r₂, r₃ for each indicator substance s₁, s₂, s₃, s₄ instead of four indicator substance regions r₁, r₂, r₃, r₄ for each indicator substance s₁, s₂, s₃, s₄ as in the first embodiment. Thus, in total it comprises 3*4=12 indicator substance regions.

Furthermore, in the second embodiment, each of the filters f₁, f₂, f₃, f₄ is arranged as a separate row in a first direction of the substrate 2. Thus, the filters f₁, f₂, f₃, f₄ form in total four rows. The three indicator substance regions r₁, r₂, r₃, for each of the indicator substances s₁, s₂, s₃, s₄ are arranged as a separate column in a second direction of the substrate 2. Thus, in total four different columns are formed. The second direction is transverse to the first direction.

In the second embodiment the filters f₁, f₂, f₃, f₄ and the indicator substance regions r₁, r₂, r₃ are arranged such that each filter f₁, f₂, f₃, f₄ provides at least one of the three indicator substance regions r₁, r₂, r₃ for each of the indicator substances s₁, s₂, s₃, s₄ with light. More specifically, the filter denoted f, provides the indicator substance region denoted r₁ for each of the indicator substances s₁, s₂, s₃, s₄ with light, the filter denoted f₂ provides the indicator substance regions denoted r₁ and r₂ for each of the indicator substances s₁, s₂, s₃, s₄ with light, the filter denoted f₃ provides the indicator substance regions denoted r₂ and r₃ for each of the indicator substances s₁, s₂, s₃, s₄ with light, and the filter denoted f₄ provides the indicator substance region denoted r₃ for each of the indicator substances s₁, s₂, s₃, s₄ with light. In addition, the filters f₁, f₂, f₃, f₄ and the indicator substance regions r₁, r₂, r₃ are arranged such that each of the 12 indicator substance regions r₁, r₂, r₃ is provided with light emerging from one of the filters f₁, f₂, f₃, f₄ in one part and from another of the filters f₁, f₂, f₃, f₄ in another part. More specifically, the indicator substance regions denoted r₁ are provided with light emerging from the filter f₁ and the filter f₂, the indicator substance regions denoted r₂ are provided with light emerging from the filter f₂ and the filter f₃, and the indicator substance regions denoted r₃ are provided with light emerging from the filter f₃ and the filter f₄.

Furthermore, the filter element 5 is shown in FIG. 2b as being provided interposed between the second side 4 and the indicator substance regions r₁, r₂, r₃. However, the filter element 5 may likewise be arranged on the first side 3 of the substrate 2. In addition, a diffuser 6 is arranged on the first side 3 of the substrate. However, the diffuser 6 may optionally be omitted.

FIG. 2c shows a variant of the second embodiment, which variant corresponds to the second embodiment except for concerning the fact that it may comprise other numbers of indicator substances and/or indicator substance regions and/or filters. In the variant of the second embodiment shown in FIG. 2c the sensor kit 1 comprises x indicator substances s₁, s₂ . . . sₓ, the filter element 5 comprises one of each of n different filters f₁, f₂ . . . fₙ, and the substrate 2 comprises (n-1) indicator substance regions r₁, r₂ . . . rₙ₋₁ for each indicator substance s₁, s₂ . . . sₓ. Light within different spectral bands emerges from each of the different filters f₁, f₂ . . . fₙ when said first side 3 of the substrate 2 is illuminated. The filters f₁, f₂ . . . fₙ and the indicator substance regions r₁, r₂ . . . rₙ₋₁ are arranged such that each filter f₁, f₂ . . . fₙ provides at least one of the (n-1) indicator substance regions r₁, r₂ . . . rₙ₋₁ for each of the indicator substances s₁, s₂ . . . sₓ with light and such that each indicator substance region r₁, r₂ . . . rₙ₋₁ is provided with light emerging from one of the filters f₁, f₂ . . . fₙ in one part and from another of the filters f₁, f₂ . . . fₙ in another part when the first side 3 of the substrate 2 is illuminated. In variants corresponding to that shown in FIG. 2c, 1≦x≦200 and 2≦n≦100.

In the variant shown in FIG. 2c each filter f₁, f₂ . . . fₙ is arranged as a separate row in a first direction of the substrate 2 and the (n-1) indicator substance regions r₁, r₂ . . . rₙ₋₁ for each of said indicator substances s₁, s₂ . . . sₓ are arranged as a separate column in a second direction of the substrate 2. Alternatively the filters f₁, f₂ . . . fₙ and the indicator substance regions r₁, r₂ . . . rₙ₋₁ may be arranged in any other way than that specific arrangement shown in FIG. 2c. However, they are then also arranged such that each filter f₁, f₂ . . . fₙ provides at least one of the (n-1) indicator substance regions r₁, r₂ . . . rₙ₋₁ for each of the indicator substances s₁, s₂ . . . sₓ with light and such that each indicator substance region r₁, r₂ . . . rₙ₋₁ is provided with light emerging from one of the filters f₁, f₂ . . . fₙ in one part and from another of the filters f₁, f₂ . . . fₙ in another part when the first side 3 of the substrate 2 is illuminated.

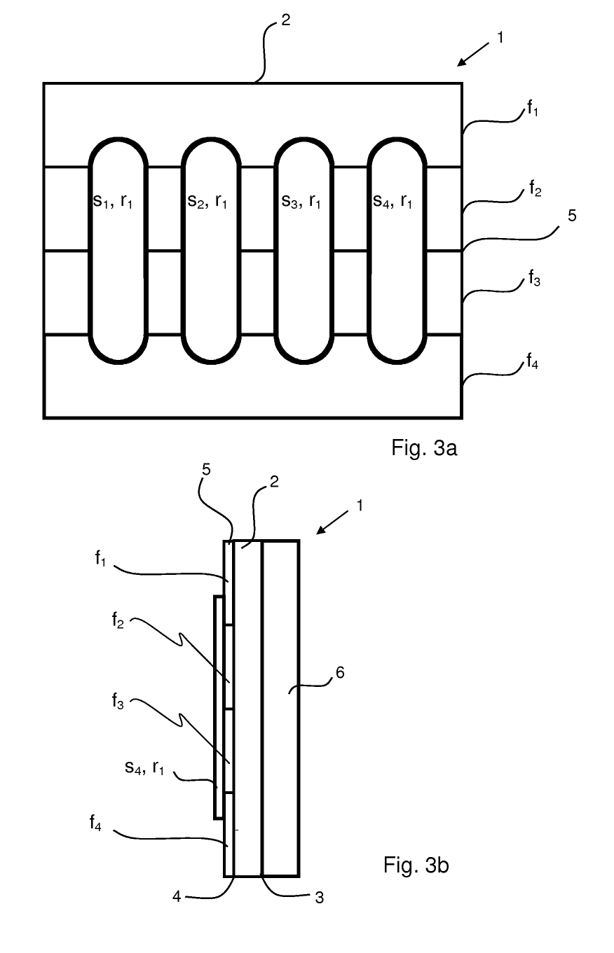

FIGS. 3a and 3b show schematically a top view and a side view, respectively, of a third embodiment of a sensor kit 1 according to the invention. The third embodiment corresponds to the first embodiment of the invention except for concerning the numbers of indicator substance regions, the positioning thereof in relation to the filters and the position of the filter element. Thus, in the third embodiment, the substrate 2 comprises four different indicator substances s₁, s₂, s₃, s₄ and the filter element 5 comprises one of each of four different filters f₁, f₂, f₃, f₄ in correspondence with the first embodiment. The different filters f₁, f₂, f₃, f₄ are designed such that light within different spectral bands emerge from them when the first side 3 of the substrate 2 is illuminated with light from a light source. However, the substrate 2 comprises only one indicator substance region r,₁ for each indicator substance s₁, s₂, s₃, s₄. Thus, in total it comprises 1*4=4 indicator substance regions.

Furthermore, in the third embodiment, each of the filters f₁, f₂, f₃, f₄ is arranged as a separate row in a first direction of the substrate 2. Thus, the filters ft, f₂, f₃, f₄ form in total four rows. The indicator substance region r₁ for each of the indicator substances s₁, s₂, s₃, s₄ is arranged as a separate column in a second direction of the substrate 2. Thus, in total tour different columns are formed. More specifically, the indicator substance region r₁ is an elongated region extending in the second direction. The second direction is transverse to the first direction.

In the third embodiment the filters f₁, f₂, f₃, f₄ and the indicator substance regions r₁ are arranged such that each filter f₁, f₂, f₃, f₄ provides each indicator substance region r₁ with light. Thus, the filters f₁, f₂, f₃, f₄ and the indicator substance regions r₁ are arranged such that each of the four indicator substance regions r₁ is provided with light emerging from all filters f₁, f₂, f₃, f₄. Furthermore, the filters f₁, f₂, f₃, f₄ and the indicator substance regions r₁ are arranged such that each indicator substance region r₁ is provided with light emerging from the respective filters f₁, f₂, f₃, f₄ in different parts.

Furthermore, the filter element 5 is shown in FIG. 3b as being provided interposed between the second side 4 and the indicator substance regions r₁. However, the filter element 5 may likewise be arranged on the first side 3 of the substrate 2. In addition, a diffuser 6 is arranged on the first side 3 of the substrate. However, the diffuser 6 may optionally be omitted.

FIG. 3c shows a top view of a variant of the third embodiment, which variant corresponds to the third embodiment except for concerning the fact it they may comprise other numbers of indicator substances and/or indicator substance regions and/or filters. In the variant of the third embodiment shown in FIG. 3c the sensor kit 1 comprises x indicator substances s₁, s₂ . . . sₓ, the filter element 5 comprises one of each of n different filters f₁, f₂ . . . fₙ, and the substrate 2 comprises one indicator substance region r₁ for each indicator substance s₁, s₂ . . . sₓ. Light within different spectral bands emerges from each of the different filters f₁, f₂ . . . fₙ when the first side 3 of the substrate 2 is illuminated. The filters f₁, f₂ . . . fₙ and the one indicator substance region r₁ for each indicator substance (s₁, s₂ . . . sₓ) are arranged such that each filter f₁, f₂ . . . fₙ provides each indicator substance region r₁ with light and such that each indicator substance region r₁ is provided with light emerging from the respective filters f_{l, f}₂ . . . fₙ in different parts when the first side 3 of the substrate 2 is illuminated. In variants corresponding to that shown in FIG. 3c, 1≦x≦200 and 2≦n≦100.

In the variant shown in FIG. 3c each filter f₁, f₂ . . . fₙ is arranged as a separate row in a first direction of the substrate 2 and the indicator substance regions r₁ for each of said indicator substances s₁, s₂ . . . sₓ are arranged as a separate column in a second direction of the substrate 2. Alternatively, the tilters f₁, f₂ . . . fₙ and the indicator substance regions r₁ may be arranged in any other way (not shown) than the arrangement shown in FIG. 3c. However, they are then also arranged such that each filter f₁, f₂ . . . fₙ provides each indicator substance region r₁ with light and such that each indicator substance region r₁ is provided with light emerging from the respective filters f₁, f₂ . . . fₙ in different parts when the first side 3 of the substrate 2 is illuminated.

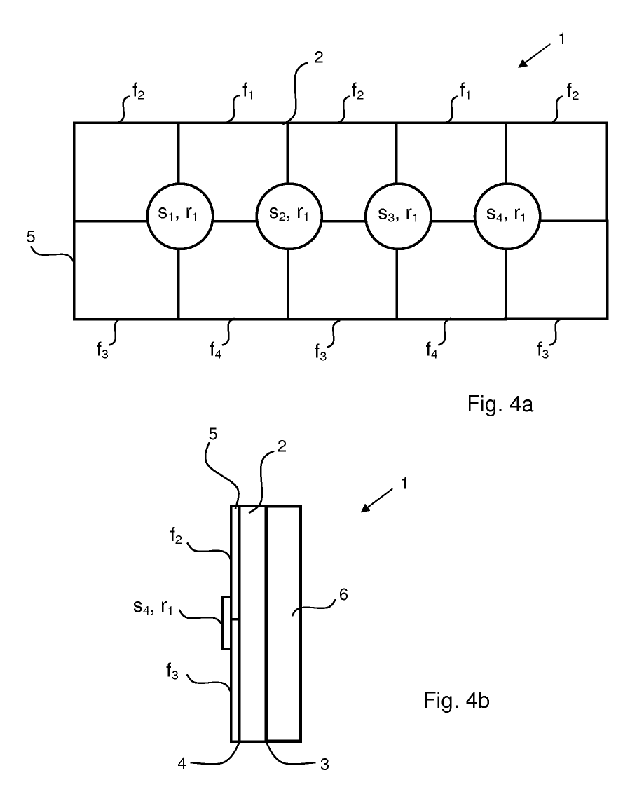

FIGS. 4a and 4b show schematically a top view and a side view, respectively, of a fourth embodiment of a sensor kit 1 according to the invention. The fourth embodiment corresponds to the first embodiment of the invention except for concerning the numbers of indicator substance regions, the numbers of filters, the positioning of the indicator substance regions in relation to the filters and the position of the filter element. Thus, in the fourth embodiment, the substrate 2 comprises four different indicator substances s₁, s₂, s₃, s₄ in accordance with the first embodiment. However, the substrate 2 comprises one indicator substance region r₁ for each indicator substance s₁, s₂, s₃, s₄. Thus, in total it comprises 1*4=4 indicator substance regions. The filter element 5 comprises at least one of each of four different filters f₁, f₂, f₃, f₄. The different filters f₁, f₂, f₃, f₄ are designed such that light within different spectral bands emerge from them when the first side 3 of the substrate 2 is illuminated with light from a light source. More specifically, the fourth embodiment comprises two filters denoted f₁, three filters denoted f₂, three filters denoted f₃ and two filters denoted f₄.

As may be seen in FIG. 4a, the filters f₁, f₂, f₃, t₄ of the filter element 5 and the indicator substance regions r₁ are in the fourth embodiment arranged such that each indicator substance region r₁ is provided with light emerging from one of each of the four different filters f₁, f₂, f₃, f₄. Thus, one of each of the tour different filters f₁, f₂, f₃, f₄ provides each indicator substance region r, with light. Furthermore, the filters f₁, f₂, f₃, f₄ and the indicator substance regions r, are arranged such that each indicator substance region r, is provided with light emerging from the respective different filters f₁, f₂, f₃, f₄ in different parts when the first side 3 of the substrate 2 is illuminated.

More specifically, in the fourth embodiment, the filters denoted f₁ and f₂ are arranged alternating in one row in a first direction of the substrate 2, while the filters denoted f₃ and f₄ are arranged alternating in another row in the first direction of the substrate 2. The indicator substance regions r₁ are also provided in a row in the first direction of the substrate 2, whereby the filters f₁, f₂, f₃, f₄, the indicator substance regions r, and the three rows are arranged such that each indicator substance area r₁ is provided with light emerging from one of each of the different filters, i.e. from one filter denoted f₁, one filter denoted f₂, one filter denoted f₃ and one filter denoted f₄.

Furthermore, the filter element 5 is shown in FIG. 4b as being provided interposed between the second side 4 and the indicator substance regions r₁. However, the filter element 5 may likewise be arranged on the first side 3 of the substrate 2. In addition, a diffuser 6 is arranged on the first side 3 of the substrate 2. However, the diffuser 6 may optionally be omitted.

Furthermore, the fourth embodiment may be varied such that the sensor kit 1 comprises other numbers of indicator substances and/or indicator substance regions and/or filters than those mentioned above. Such variants correspond to the fourth embodiment except for concerning the fact that they may comprise other numbers of indicator substances and/or indicator substance regions and/or filters. However, they comprise at least two indicator substances and at least one of each of at least two different filters, from which light within different spectral bands emerges when the first side of the substrate is illuminated. In such variants (not shown) the sensor kit 1 comprises x indicator substances s₁, s₂ . . . sₓ, the filter element 5 comprises at least one of each of n different filters f₁, f₂ . . . fₙ, and the substrate 2 comprises one indicator substance region r₁ for each indicator substance s₁, s₂ . . . sₓ. In these variants 1≦x≦200 and 2≦n≦100. Light within different spectral bands emerges from each of the different filters f₁, f₂ . . . fₙ when the first side 3 of the substrate 2 is illuminated. The filters f₁, f₂ . . . fₙ and the one indicator substance region r₁ for each indicator substance (s₁, s₂ . . . sₓ) are arranged such that one of each of the n different filters f₁, f₂ . . . fₙ provides each indicator substance region r₁ with light and such that each indicator substance region r₁ is provided with light emerging from the respective different filters f₁, f₂ . . . fₙ in different parts when the first side 3 of the substrate 2 is illuminated.

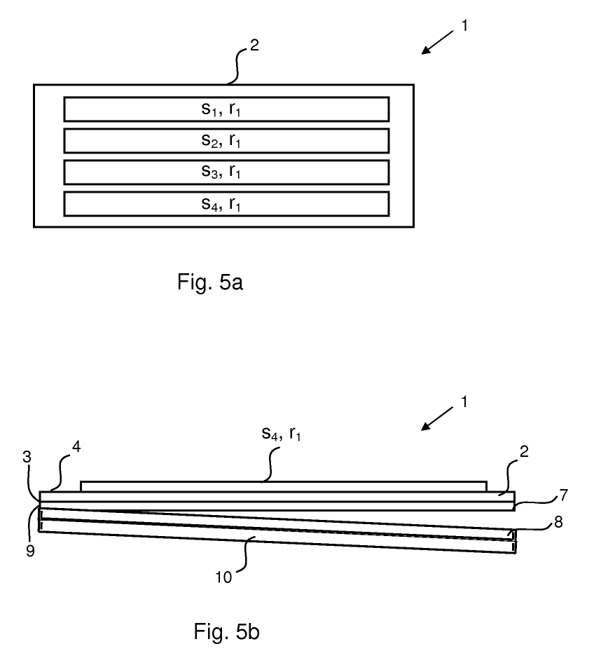

FIG. 5a and 5b show a top view and a side view respectively of a fifth embodiment of the sensor kit 1 according to the invention. The fifth embodiment corresponds to the first embodiment of the invention except for concerning the numbers of indicator substance regions and the filter element. In the fifth embodiment, the sensor kit 1 comprises four indicator substances s₁, s₂, s₃, s₄ and the substrate 2 comprises one indicator substance region r, for each indicator substance s₁, s₂, s₃, s₄. Each indicator substance region r₁ is an elongated region extending in a first direction of the substrate 2. The filter element 5 is a Fabry Perot etalon comprising a first and a second semitransparent mirror 7, 8. The first mirror 7 is arranged such that it is in contact with the first side 3 of the substrate 2 and such that it extends parallel to the substrate 2. The second mirror 8 is arranged such that light firstly passes through the second mirror 8 and thereafter through the first mirror 7 when the first side 3 of the substrate 2 is illuminated. The second mirror 8 diverges from a first edge 9 of the first mirror 7, which first edge 9 extends in a direction transverse to the first direction, whereby there is a wedge-shaped space between the two mirrors 7, 8. The second mirror 8 may be in contact with the first mirror 7 at the first edge 9, as shown in FIG. 5b. Alternatively, there may be a certain distance between the two mirrors 7, 8 at the first edge 9.

When the first side 3 of the substrate 2 is illuminated, light emerging from the first transparent mirror 7 has different wavelengths depending on where along the first direction of the substrate 2 that it emerges. This is due to the tact that there is a wedge-shaped space between the two mirrors 7, 8. The wavelength increases in the first direction away from the first edge 9, i.e. it is smallest at the first edge 9. Thus, the Fabry Perot etalon may be seen as being constituted by n consecutive different filters f₁, f₂ . . . fₙ in the first direction of the substrate 2, whereby light within different spectral bands emerges from the different filters and whereby 2≦n≦100. Thus, the respective substance regions r₁ are provided with light within different spectral bands along the first direction of the substrate 2.

In the example shown in FIGS. 5a and 5b the second mirror 8 is attached to a transparent plate 10. The first mirror 7 is also attached to a transparent plate, which is constituted by the substrate 2.

In variants of the fifth embodiment, the sensor kit 1 comprises other numbers of indicator substances and indicator substance regions. Then, the sensor kit 1 may comprise x indicator substances s₁, s₂ . . . sₓ and one indicator substance region r₁ for each indicator substance s₁, s₂ . . . sₓ whereby 1≦x≦200.

Furthermore, in a broad general definition any of the above described embodiments of the sensor kit 1 and alternatives and variants thereof may be defined as a sensor kit 1 for detecting an analyte in a test environment comprising:
x indicator substances s₁, s₂ . . . sₓ, whereby 1<x≦200, whereby each indicator substance s₁, s₂ . . . sₓ has a specific spectral response to the analyte; and
a substrate 2 arranged for carrying the indicator substances s₁, s₂ . . . sₓ, whereby the substrate 2 comprises a first side 3 and a second side 4 opposite to the first side 3, whereby the substrate 2 is arranged to be illuminated by a light source on the first side 3, whereby the substrate 2 comprises at least one indicator substance region r₁, r₂ . . . rₙ arranged adjacent to the second side 4, whereby each indicator substance region r₁, r₂ . . . rₙ is arranged for carrying one indicator substance s₁, s₂ . . . sₓ and whereby the substrate 2 comprises at least one indicator substance region r₁, r₂ . . . rₙ for each indicator substance s₁, s₂ . . . sₓ, whereby

the sensor kit 1 further comprises a filter element 5 integrated with the substrate 2, which filter element 5 is arranged such that light firstly passes through the filter element 5 and thereafter through the at least one indicator substance region r₁, r₂ . . . rₙ when the first side 3 of the substrate 2 is illuminated and which filter element 5 comprises at least one of each of n different filters f₁, f₂ . . . fₙ, whereby 2≦n≦100 and whereby light within different spectral bands emerges from each of the different filters f₁, f₂ . . . fₙ when the first side 3 of the substrate 2 is illuminated, whereby the filters f₁, f₂ . . . fₙ of the filter element 5 and the at least one indicator substance region r₁, r₂ . . . rₙ are arranged such that at least one of each of at least two different filters f₁, f₂ . . . fₙ respectively provides at least one indicator substance region r₁, r₂ . . . rₙ with light when the first side 3 of the substrate 2 is illuminated.

Furthermore, this general definition may be further limited by the fact that the filters f₁, f₂ . . . fₙ of the filter element 5 and the at least one indicator substance region r₁, r₂ . . . rₙ are arranged such that each filter f₁, f₂ . . . fₙ of the filter element 5 provides at least one indicator substance region r₁, r₂ . . . rₙ with light and such that each indicator substance region r₁, r₂ . . . rₙ is provided with light emerging from at least one of the filters f₁, f₂ . . . fₙ of the filter element 5 when the first side 3 of the substrate 2 is illuminated.

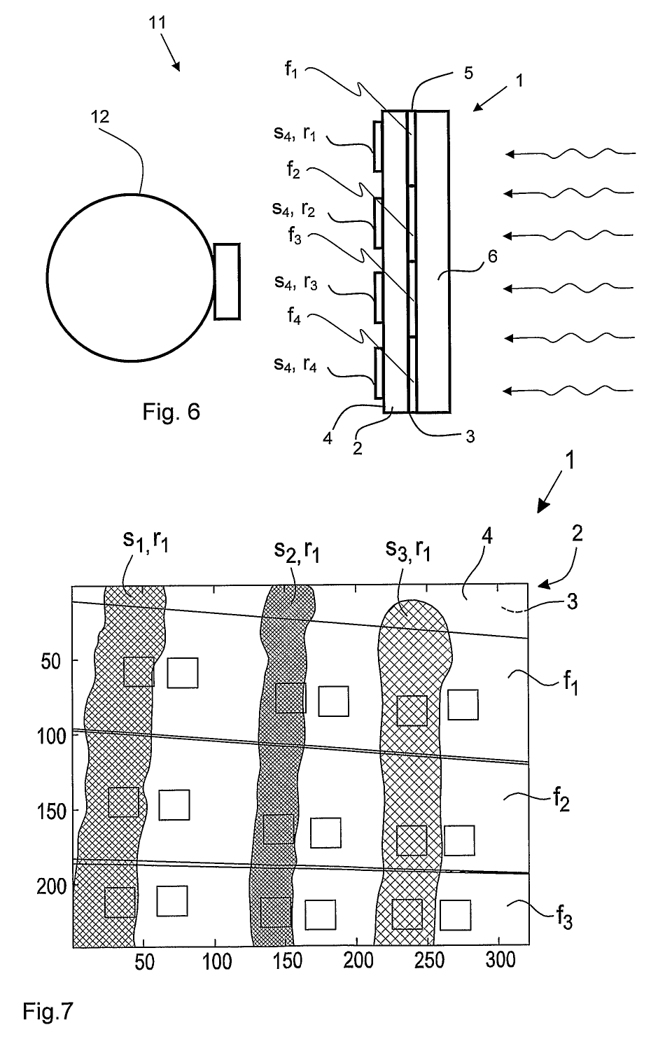

Furthermore, the present invention provides a system for detection of an analyte in a test environment. The system according to the invention comprises the sensor kit 1 according to any of the embodiments or alternatives or variants thereof described herein. One example of a system 11 according to the invention is shown in FIG. 6 in which the first embodiment of the sensor kit 1 is comprised. The sensor kit 1 shown in FIG. 6 comprises further a diffuser 6. In addition, the system 11 according to the invention comprises a detector 12 arranged to detect light emerging from the indicator substance areas r₁, r₂ . . . rₙ, i.e. the detector 12 is arranged to detect the spectral response of the indicator substances s₁, s₂ . . . sₓ. The detector 12 may be any detector suitable to detect the spectral response of the indicator substances s₁, s₂ . . . sₓ and it is preferably selected from the group consisting of: a web camera, a digital camera, a digital camera in a mobile phone and a video camera. In case a diffuser 6 is comprised in the sensor kit 1 it homogenizes the background illumination observed by the detector 12.

The sensor kit 1 and the system 11 according to the invention may be utilized for detection of an analyte in a test environment. The use of the sensor kit 1 according to the invention will now be exemplified by a description of the use of the first embodiment of the sensor kit 1 in a system 11 according to the invention, whereby reference is made to FIG. 6.

As mentioned above, the indicator substances s₁, s₂, s₃, s₄ may either be provided in the respective indicator substance regions r₁, r₂, r₃, r₄ after manufacture of the sensor kit 1 or may be provided separate from the substrate 2. In case they are provided in the respective indicator substance regions during manufacture, the sensor kit may be ready to be used at delivery to a user. In case the indicator substances are provided separate from the substrate 2, they must of course be provided in the respective indicator substance regions by the user before use of the sensor kit for detecting an analyte in a test environment.

Furthermore, before the substrate 2 with the indicator substances s₁, s₂, s₃, s₄ is utilized for detection of an analyte in a test environment, i.e. before the indicator substances s₁, s₂, s₃, s₄ are brought into contact with the test environment in which it is to be detected whether an analyte is present or not, the initial spectral response of the indicator substances s₁, s₂, s₃, s₄ is preferably detected. The initial spectral response of the indicator substances s₁, s₂, s₃, s₄ is detected by illuminating the first side 3 of the substrate 2 with light from a light source, such as e.g. any light source providing white light. For example, any “ordinary” light source, room illumination or sun light may be utilized as light source. In FIG. 6 the light with which the first side 3 of the substrate 2 is illuminated is schematically shown as a plurality of wave-formed arrows. The initial spectral response of the indicator substances s₁, s₂, s₃, s₄ is detected by means of the detector 12.

By detecting the initial spectral response, the spectral response of the indicator substances s₁, s₂, s₃, s₄ before any possible interaction with the analyte is detected. This initial detection may also be utilized to identify the indicator substances s₁, s₂, s₃, s₄, e.g. to certify that the correct sensor kit 1 is utilized or to determine the exact locations, e.g. coordinates, of the different indicator substances s₁, s₂, s₃, s₄ on the substrate 2.

After detection of the initial spectral response, the indicator substances s₁, s₂, s₃, s₄ is brought into contact with the test environment in which it is to be detected whether an analyte is present or not and the spectral response is detected. In case it is to be tested whether an analyte is present in a gaseous sample, the gaseous sample may be brought into contact with the indicator substances s₁, s₂, s₃, s₄. For example, the substrate 2 may then e.g. be positioned in a sealed test chamber into which the gaseous sample thereafter is introduced. Alternatively, the substrate 2 with the indicator substances may be brought into an environment comprising the gaseous sample. In case it is to be tested whether a liquid or solid sample comprises the analyte to be detected, the samples may either be added to the indicator substance regions r₁, r₂, r₃, r₄ or the substrate 2 may be brought into the samples.

The spectral response may be detected during exposure, or after exposure, to the test environment. Furthermore, the spectral response may be detected at several points of time during exposure to the test environment. The detected spectral response is compared to the initial spectral response and any changes are detected.

As mentioned above, each indicator substance s,, s₂, s₃, s₄ comprised in the sensor kit 1 has a specific spectral response to the analyte to be detected, i.e. each indicator substance s₁, s₂, s₃, s₄ has a specific spectral response in case the analyte is present in the test environment. The specific spectral response of the respective indicator substances s₁, s₂, s₃, s₄ to the analyte to be detected may either be changed or unchanged compared to the spectral response thereof in case the analyte is not present. However, at least one of the indicator substances s₁, s₂, s₃, s₄ comprised in the sensor kit 1 changes its spectral response in case the analyte to be detected is present in the test environment.

Thus, all the indicator substances s₁, s₂, s₃, s₄ of the sensor kit 1 in combination have a specific spectral response to the analyte to be detected, i.e. they provide in combination a spectral response distinct to an analyte to be detected. The spectral response, or the change of the spectral response, of the indicator substances s₁, s₂, s₃, s₄ in combination is utilized to detect an analyte. By knowing which changes the analyte to be detected gives rise to, it may be determined whether the analyte is present or not in the test environment.

In the first embodiment of the sensor kit 1 each indicator substance s₁, s₂, s₃, s₄ is provided in four different indicator substance regions r₁, r₂, r₃, r₄ and each of the tour indicator substance regions r₁, r₂, r₃, r₄ for each respective indicator substance s,, s₂, s₃, s₄ is provided with light within different spectral bands when illuminated by a light source. Thus, each indicator substance s₁, s₂, s₃, s₄ is provided with light within a plurality of specific different spectral bands when illuminated by a light source. This is due to the integration of the filters f₁, f₂, f₃, f₄ with the substrate 2, which guarantees that each indicator substance region r₁, r₂, r₃, r₄ is provided with light within a specific spectral band.

Thus, when the first embodiment is utilized it may be determined for each of the indicator substances s₁, s₂, s₃, s₄ comprised in the sensor kit 1 whether it, when exposed to a test environment, changes its spectral response within those spectral bands within which the filters allow light to pass through. In other words, when the first embodiment is utilized it may be determined for each of the indicator substances s₁, s₂, s₃, s₄ comprised in the sensor kit 1 whether it, when exposed to a test environment, changes its spectral response within a plurality of different spectral bands. The same applies of course correspondingly for all embodiments of the sensor kit 1 according to the invention and alternatives and variants thereof. The sensor kit 1 according to the invention may, thus, be utilized for spectral fingerprinting of the indicator substances.

Furthermore, the sensor kit 1 according to the invention eliminates the need of utilization of a specific light source, such as e.g. a display as in CSPT or any other light source capable of delivering light within a plurality of specific spectral bands, in order to provide the indicator substances with light within a plurality of specific spectral bands. Thus, it is by means of the sensor kit 1 according to the invention possible to perform CSPT-like measurements, but without a display such as e.g. a computer screen for illuminating the indicator substances. The present invention enables CSPT determination in situations where the computer screen (or mobile phone) illumination is not available or inconvenient. The invention also simplifies the handling and arrangement of the sensor kit, since it does not need to be interposed between the screen and the image detectors.

The sensor kit 1 according to the invention may be designed such that it is suited to detect specific analytes. It may also be designed such that it is suited to determine the spectral characteristics of certain indicator substances, i.e. the filters may be chosen such that they allow light to pass through within those spectral bands which are interesting for the certain indicator substances. The spectral characteristics of the respective filters may, thus, be designed for extracting the most distinctive spectral fingerprints of a given set of indicator substances.

The sensor kit according to the invention can be utilized for detection of sanitary or environmental parameters provided that these parameters can be traced by proper chemistry as a noticeable optical response, and in particular as an spectral response. Examples of applications include: enzyme linked immunosorbent assays (ELISA) for the diagnosis of inflammatory diseases associated with the presence of antineutrophil cytoplasm antibodies (ANCA), cell viability tests (e.g. MTT assays), G-protein coupled receptor mediated responses in pigment containing cell assays detecting adrenaline, commercial colorimetric test for pH, glucose, ketones, leukocytes, nitride, proteins creatinine, potassium and blood in urine. Environmental contaminants such as NOx, CO, NH3 and amines can also be detected in liquid and gas phase as well as complex odors characterizing fish freshness. Other examples include bacteria identification and potential indicators for early diagnosis of lung cancer.

The present invention brings the analytical power of standard CSPT performed with computer screens as light sources or with selected mobile phones with cameras on the same side of the screen to whatever image recording medium and arbitrarily available light sources.

### Experimental

One experiment involving detection of two different analytes in a test environment with a sensor kit according to the invention will now be described in detail. An experimental implementation of the variant of the third embodiment of the sensor kit 1 shown in FIG. 3c was constructed. The experimental implementation of the sensor kit 1 is shown in a top view in FIG. 7. A regular glass cut to 2.5×2.5 cm, i.e. a glass slide, was utilized as the substrate 2 having a first side 3 and an opposite second side 4. Three wide band filters f₁, f₂, f₃ in the red, green and blue regions, i.e. filters from which light within the red, green and blue spectral bands emerges when the first side 3 of the glass slide 2 is illuminated, were arranged as three horizontal stripes, i.e. as three rows, on the second side 4 of the glass slide 2. The three wide band filters f₁, f₂, f₃ were printouts on transparent foil of pure red, green and blue areas. Three different indicator substances s₁, s₂, s₃ were then deposited on top of the filters f₁, f₂, f₃ in three transverse stripes, i.e. in three columns, constituting indicator substance regions r₁. The indicator substance denoted s₁ was a Ge Corrole, the indicator substance denoted s₂ was Mn porphyrin (MnTPP), and the indicator substance denoted s₃ was Zn porphyrin (ZnTPP). Each indicator substance was embedded in a polymer matrix.

More specifically, metalloporphyrins were synthesized according to literature methods (12). The indicator substances s were then prepared by deposition of drops of PVC-membrane solutions (1 wt. % of porphyrin, PVC/bis(2-ethylhexyl) sebacate (1:2) polymeric matrix) in tetrahydrofuran onto the substrate, i.e. onto the filters. Evaporation of the solvent led to the formation of PVC/porphyrin membrane.

Thus, the experimental implementation of the sensor kit 1 comprised 3 different indicator substances, one of each of three different filters in the filter element and one indicator substance region for each indicator substance. The filters and the indicator substance regions are arranged such that each filter provides each indicator substance with light and such that each indicator substance region is provided with light emerging from the respective different filters in different parts when the first side 3 of the glass slide 2 is illuminated.

The sensor kit 1 shown in FIG. 7 was utilized for detecting the analytes trietylamine and acetic acid. For the detection, the sensor kit 1 with the indicator substances and filters was introduced into a tight gas cell with glass walls, where it was exposed to controlled concentrations of different gases with the aid of an automatic gas mixing system. An arbitrarily white light source was utilized as light source in the detection experiment. In the test chamber, the sensor kit 1 was exposed to air—triethylamine (1 min)—triethylamine (5 min)—air (20 min)—acetic acid (1 min)—acetic acid (5 min). After each exposure the first side 3 of the glass slide 2 was illuminated with light from the light source and the spectral response of the indicator substances detected by a web camera as an image detector on the second side 4 of the glass slide 2. The web camera was a Logitech Quickcam pro 4000 operating at a resolution of 320×240 pixels.

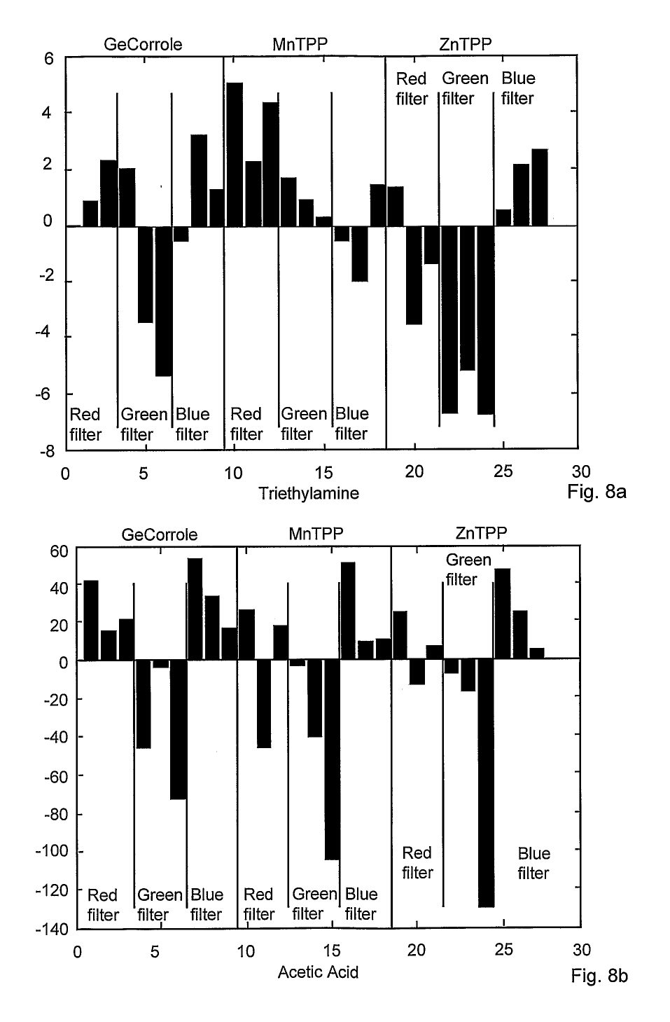

Squares in FIG. 7 indicate regions of interest (ROIs) selected for the numerical processing of the information. The average value of intensities within these regions is used for the evaluation. These intensities are naturally unfolded in the red, green and blue levels given by the camera channels. The intensity of each channel recorded from each region of interest provides a spectral signature of the indicator substances that specifically change upon exposure to an analyte to be detected. The intensities of the ROIs on the indicators substances are subtracted by the intensities of the ROIs on the filters besides them. These signals are collected in each camera channel for each indicator substance and all substance signatures concatenated in a sensor kit signature as shown in FIGS. 8a and 8b. The fingerprints shown in FIGS. 8a and 8b represent the results of the above mentioned exposures trietylamine (5 min) and acetic acid (5 min), respectively.

The web camera is a color imaging device, which means that each picture it takes is composed by three levels acquired through red, green and blue filters in the camera. That is why the intensity of each pixel of the image is actually three intensities, one for each camera channel. Thus each ROI will produce three intensity values for each filter on the substrate, whereby there are 3×3=9 bars for each indicator substance in FIGS. 8a and 8b.

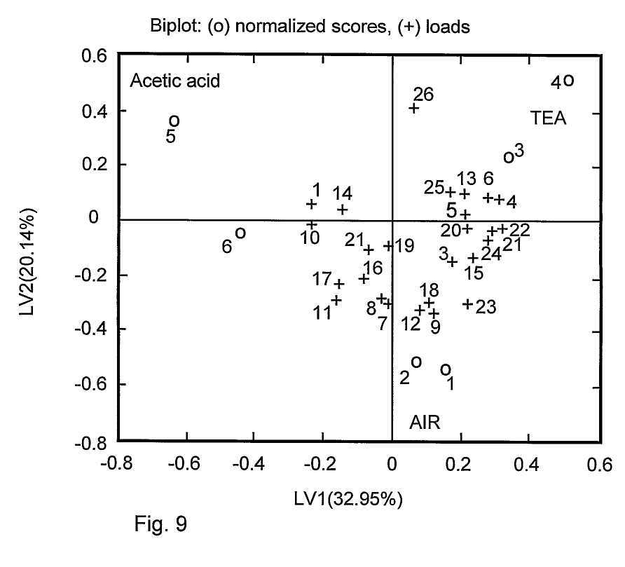

Upon exposure to different analytes the sensor kit signatures changes distinctively. Principal component analysis of these responses enable the automatic classification of these responses and the identification of the tested stimuli, which become clustered in different regions of the scores plot, such as triethylamine (TEA), air and acetic acid in the example of FIG. 9. More specifically, FIG. 9 shows the multivariate classification of fingerprints such as those in FIGS. 8a and 8b. Circles indicate scores of principal component analysis that identify different species in a two dimensional space. These techniques are commonly used in CSPT for automatic evaluations. The loads (+) correspond to experimental conditions that can be correlated to the classification performance in optimization procedures. In FIG. 9, Scores (o) 1 and 2 correspond to two fingerprints in air, while 3 and 4 correspond to 1 and 5 minutes exposure to TEA and 5 and 6 to 1 and 5 minutes exposures to acetic acid.

Thus, while there have been shown and described and pointed out fundamental novel features of the invention as applied to preferred embodiments thereof, it will be understood that various omissions and substitutions and changes in the form and details of the devices, method steps and products illustrated may be made by those skilled in the art. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### REFERENCES

1. “Computer screen as a programmable light source for visible absorption characterization of (bio)chemical assays”, D. Filippini, S. P. S. Svensson, I. Lundström, Chem. Commun. 2 (2003), 240-241.

2. “Microplate based biosensing with a computer screen aided technique”, D. Filippini, T. P. M. Andersson, S. P. S. Svensson, I. Lundström, Biosensors and Bioelectronics 19 (2003), 35-41.

3. “Computer screen illumination for the characterization of calorimetric assays”, J. Manzano, D. Filippini, l. Lundström, Sensors and Actuators B 96 (2003), 173-179.

4. “ELISA test for anti-neutrophil cytoplasm antibodies detection evaluated by a computer screen photo assisted technique”, D. Filippini, K. Tejle, I. Lundström, Biosensors and Bioelectronics 21 (2005), 266-272.

5. “Frog melanophores cultured on fluorescent microbeads: biomimic-based biosensing”, T. Andersson, D. Filippini, A. Suska, T. Johansson, S. Svensson and I. Lundström, Biosensors and Bioelectronics 21 (2005), 111-120.

6. “Computer screen photo-assisted reflectance fingerprinting”, D. Filippini, G. Comina, I. Lundström, Sensors and Actuators B 107 (2005), 580-586.

7. “Computer screen photo-assisted detection of complementary DNA strands using a luminescent zwitterionic polythiophene derivative”, D. Filippini, P. \dot{A}sberg, P. Nilsson, O. Inganäs, I. Lundström, Sensors and Actuators B 113 (2006), 410-418.

8. “Chemical sensing with familiar devices”, D. Filippini, A. Alimelli, C. Di Natale, R. Paolesse, A. D'Amico, I. Lundström, Angew. Chem. Int. Ed. (2006), 45, 1-5.

9. “Spectroscopic information retained in screen photo-assisted techniques”, D. Filippini, I. Lundström, Anal. Chim. Acta 512 (2004), 239-246.

10. “Spectral characteristics of computer screen photo-assisted classification”, D. Filippini, I. Lundström, J. Appl. Phys (2006), in press.

11. “Favored color substances and optimized illuminations for computer screen photo-assisted classification”, D. Filippini, I. Lundström, Anal. Chim. Acta. 557 (2006), 393-398.

12. J. W. Buchler, in the Porphyrins, D. Dolphin, Ed., Vol. I, 389, Academic Press, New York, (1979).

1. A sensor kit for detecting an analyte in a test environment, the sensor kit comprising:
x indicator substances, whereby 1≦x≦200, whereby each indicator substance has a specific spectral response to said analyte;
a substrate arranged for carrying said indicator substances, whereby said substrate comprises a first side and a second side opposite to said first side, whereby said substrate is arranged to be illuminated by a light source on said first side, whereby said substrate comprises at least one indicator substance region arranged adjacent to said second side, whereby each indicator substance region is arranged for carrying one indicator substance and whereby said substrate comprises at least one indicator substance region for each indicator substance; and
a filter element integrated with said substrate, which filter element is arranged such that light firstly passes through said filter element and thereafter through said at least one indicator substance region when said first side of said substrate is illuminated and which filter element comprises at least one of each of n different filters, whereby 2≦n≦100 and whereby light within different spectral bands emerges from each of said different filters when said first side of said substrate is illuminated, whereby said filters of said filter element and said at least one indicator substance region are arranged such that at least one of each of at least two different filters respectively provides at least one indicator substance region with light when said first side of said substrate is illuminated.

2. The sensor kit according to claim 1, wherein said filters of said filter element and said at least one indicator substance region are arranged such that each filter of said filter element provides at least one indicator substance region with light and such that each indicator substance region is provided with light emerging from at least one of said filters of said filter element when said first side of said substrate is illuminated.

3. The sensor kit according to claim 1, wherein said filter element is arranged on said first side of said substrate.

4. The sensor kit according to claim 1, wherein said filter element is interposed between said second side of said substrate and said indicator substance regions.

5. The sensor kit according to claim 1, wherein said substrate comprises a plate comprising a plurality of wells, whereby each well constitutes an indicator substance region.

6. The sensor kit according to claim 1, further comprising:
x indicator substances, wherein said filter element comprises one of each of n different filters whereby light within different spectral bands emerges from each of said different filters when said first side of said substrate is illuminated, and said substrate comprises n indicator substance regions for each indicator substance, whereby 1≦x≦200 and 2≦n≦100, whereby said filters of said filter element and said indicator substance regions are arranged such that each filter of said filter element provides one of said n indicator substance regions for each of said indicator substances with light and such that each indicator substance region is provided with light emerging from one of said filters only when said first side of said substrate is illuminated.

7. The sensor kit according to claim 6, wherein each filter of said filter element is arranged as a separate row in a first direction of said substrate, and wherein said n indicator substance regions for each of said indicator substances are arranged as a separate column in a second direction of said substrate, whereby said second direction is transverse to said first direction.

8. The sensor kit according to claim 1, wherein said sensor kit comprises x indicator substances, wherein said filter element comprises one of each of n different filters, whereby light within different spectral bands emerges from each of said different filters when said first side of said substrate is illuminated, and said substrate comprises indicator substance regions for each indicator substance, whereby 1≦x≦200 and 2≦n≦100, whereby said filters of said filter element and said indicator substance regions are arranged such that each filter of said filter element provides at least one of said indicator substance regions for each indicator substance with light and such that each indicator substance region is provided with light emerging from one of said filters in one part and with light emerging from another of said filters in another part when said first side of said substrate is illuminated.

9. The sensor kit according to claim 8, wherein each filter of said filter element is arranged as a separate row in a first direction of said substrate, and wherein said indicator substance regions for each of said indicator substance are arranged as a separate column in a second direction of said substrate, whereby said second direction is transverse to said first direction.

10. The sensor kit according to claim 1, wherein said sensor kit comprises x indicator substances, wherein said filter element comprises one of each of n different filters, whereby light within different spectral bands emerges from each of said different filters when said first side of said substrate is illuminated, and said substrate comprises one indicator substance region for each indicator substance whereby 1≦x≦200 and 2≦n≦100, whereby said filters of said filter element and said one indicator substance region for each indicator substance are arranged such that each filter provides each indicator substance region with light and such that each indicator substance region is provided with light emerging from the respective different filters in different parts when said first side of said substrate is illuminated.

11. The sensor kit according to claim 10, each filter is arranged as a separate row in a first direction of said substrate, and wherein each indicator substance region is arranged as an elongated indicator substance region in a separate column in a second direction of said substrate, whereby said second direction is transverse to said first direction.

12. The sensor kit according to claim 1, wherein said sensor kit comprises x indicator substances, wherein said filter element comprises at least one of each of n different filters, and said substrate comprises one indicator substance region for each indicator substance, whereby 1≦x≦200 and 2≦n≦100, whereby said filters of said filter element and said one indicator substance region for each indicator substance are arranged such that one of each of said n different filters provides each indicator substance region with light and such that each indicator substance region is provided with light emerging from the respective different filters in different parts when said first side of said substrate is illuminated.

13. The sensor kit according to claim 1, wherein said sensor kit comprises x indicator substances, wherein said substrate comprises one indicator substance region for each indicator substance, whereby each indicator substance region is an elongated region extending in a first direction of said substrate, whereby said filter element is a Fabry Perot etalon comprising a first and a second semitransparent mirror, whereby said first mirror is arranged such that it is in contact with said first side of said substrate and such that it extends parallel to the substrate, whereby said second mirror is arranged such that light firstly passes through said second mirror and thereafter through said first mirror when said first side of said substrate is illuminated, whereby said second mirror diverges from a first edge of said first mirror, which first edge extends in a direction transverse to said first direction, whereby there is a wedge-shaped space between the two mirrors.

14. The sensor kit according to claim 1, wherein said indicator substances are present in said respective indicator substance regions.

15. The sensor kit according to claim 1, wherein said indicator substances are provided separate from said substrate, whereby said indicator substances are arranged to be provided in said respective indicator substance regions before use of said sensor kit.

16. The sensor kit according to claim 1, further comprising:
a diffuser integrated with said substrate, whereby said diffuser is arranged such that light firstly passes through said diffuser and thereafter through said filter element when said first side of said substrate is illuminated.

16. The sensor kit according to claim 1, wherein the indicator substances are selected from the group consisting of: porphyrins, metalloporphyrins, chlorines, chlorophylls, phtahalocyanines, salens, fluorophores, conductive polymers, fluorescence amplifying proteins, polythiofenes, nanoparticles and plasmonic nanoparticles.

17. The sensor kit according to claim 17, wherein the indicator substances are metalloporphyrines having a metal ion selected from the group consisting of Sn⁴⁺, Co³⁺, Cr³⁺, Mn³⁺, Fe³⁺, Co²⁺; Cu²⁺, Ru²⁺, Zn²⁺ and Ag²⁺.

18. A system for detecting an analyte in a test environment, the system comprising:
a sensor kit x indicator substances, whereby 1≦x≦200 whereby each indicator substance has a specific spectral response to said analyte; a substrate arranged for carrying said indicator substances, whereby said substrate comprises a first side and a second side opposite to said first side, whereby said substrate is arranged to be illuminated by a light source on said first side, whereby said substrate comprises at least one indicator substance region arranged adjacent to said second side, whereby each indicator substance region is arranged for carrying one indicator substance and whereby said substrate comprises at least one indicator substance region for each indicator substance; and a filter element integrated with said substrate, which filter element is arranged such that light firstly passes through said filter element and thereafter through said at least one indicator substance region when said first side of said substrate is illuminated and which filter element comprises at least one of each of n different filters, whereby 2≦n≦100 and whereby light within different spectral bands emerges from each of said different filters when said first side of said substrate is illuminated, whereby said filters of said filter element and said at least one indicator substance region are arranged such that at least one of each of at least two different filters respectively provides at least one indicator substance region with light when said first side of said substrate is illuminated; and
a detector arranged to detect the spectral response of said indicator substance regions, which detector is selected from the group consisting of: a web camera, a digital camera, a digital camera in a mobile phone and a video camera.
